(19) United States
(12) Patent Application Publication
(10) Pub. No.: US 2018/0306146 A1
(43) Pub. Date: Oct. 25, 2018

(54) Fuel atomizer plate for carburetors

(71) Applicant: Richard W. Thompson, Sunnyvale, CA (US)

(72) Inventor: Richard W. Thompson, Sunnyvale, CA (US)

(73) Assignee: Thompson Performance, LLC, Gold River, CA (US)

(21) Appl. No.: 15/494,504

(22) Filed: Apr. 23, 2017

(51) Int. Cl. F02M 29/04

(52) U.S. Cl. CPC F02M 29/04

(57) ABSTRACT

Disclosed in this description are modifications either attached to, or made as part of, accelerator pump discharge nozzles, tubes or pipes. These modifications include the use of a fuel atomizer plate for carburetors as either a separate device placed beneath or on top of an accelerator pump discharge nozzle, tube or pipe, or simply located in the fuel stream of an accelerator pump discharge nozzle, tube or pipe, or a fuel atomizer plate for carburetors made as a single unit along with an accelerator pump discharge nozzle, tube or pipe. All are used on standard engines and assist in the atomization and homogenization of incoming fuel with incoming air to improve engine performance

### BACKGROUND

The accelerator pump discharge nozzles of most common carburetors emit streams of fuel that do not fully atomize nor mix well with the incoming air, only break up into droplets of varying size. A lot of this fuel goes unburned, so is expelled out the exhaust system without releasing, through combustion, all of its potential power. The fuel atomizer plate for carburetors is uniquely designed to atomize this fuel stream and direct it into the high-speed air stream of the carburetor's venturi perimeter, thereby using the energy created by the engine's intake stroke to atomize the fuel. The result is homogenization of incoming fuel with incoming air which is directed by the atomizer plate down the carburetor and into the combustion chambers. This creates better engine throttle response, improved performance and power gains.

Previous devices have been designed which are placed in a carburetor's fuel and air streams to attempt to create atomization. The atomizer plate is a significant improvement over any earlier device, as it has features that allow for easy installation, improved atomization, and it is uniquely shaped to create a directed flow of the atomized fuel, thus producing improved fuel/air mix delivery speed to the engine, features which other devices do not have.

### BRIEF SUMMARY OF THE INVENTION

The fuel atomizer plate for carburetors (atomizer plate) can be located in front of, underneath, on top of, or be made as one unit along with, an accelerator pump discharge nozzle. Under throttle operation, fuel is sprayed out of the accelerator pump discharge nozzle and impacts against the backside of the fins of the atomizer plate. This action breaks the fuel stream into smaller particles, increasing the surface area of the fuel.

The smaller fuel particles from the atomizer plate are then directed by the plate into the high speed air moving at the edge of the venturi (created by the engine's intake stroke and the resulting Venturi Effect in the carburetor), and the particles are then further atomized and mixed with the incoming air, forming a much more combustible mix of fuel and air. This atomized fuel and air mixture is directed by the atomizer plate down past the boosters and the throttle blades. The result is an improved air/fuel mixture delivered on a more direct route and more rapidly to the engine's combustion chambers, producing a greatly improved throttle response and engine performance.

### BRIEF DESCRIPTION OF THE DRAWINGS

FIG. 1 shows a top view of a four-barrel carburetor

FIG. 2 is a second view of FIG. 1 with an embodiment of the fuel atomizer plate for carburetors connected thereto.

FIG. 3 is a sectional side view of the first embodiment of the invention and its attachment below the accelerator pump discharge nozzle.

FIG. 4 is a perspective view of the first embodiment of the invention.

FIG. 5 is a sectional side view of the second embodiment of the invention and its attachment on top of the accelerator pump discharge nozzle.

FIG. 6 is a perspective view of the second embodiment of the invention.

FIG. 7 is a sectional side view of the third embodiment of the invention and its attachment on top of the accelerator pump discharge nozzle.

FIG. 8 is a perspective view of the third embodiment of the invention.

FIG. 9 is a sectional side view of the fourth embodiment of the invention, made as one unit along with an accelerator pump discharge nozzle.

FIG. 10 is a perspective view of the fourth embodiment of the invention.

FIG. 11 is a sectional side view of the fifth embodiment of the invention, made as one unit along with an accelerator pump discharge nozzle.

FIG. 12 is a perspective view of the fifth embodiment of the invention.

FIG. 13 is a perspective view of the six embodiment of the invention.

### DETAILED DESCRIPTION AND BEST MODE OF IMPLEMENTATION

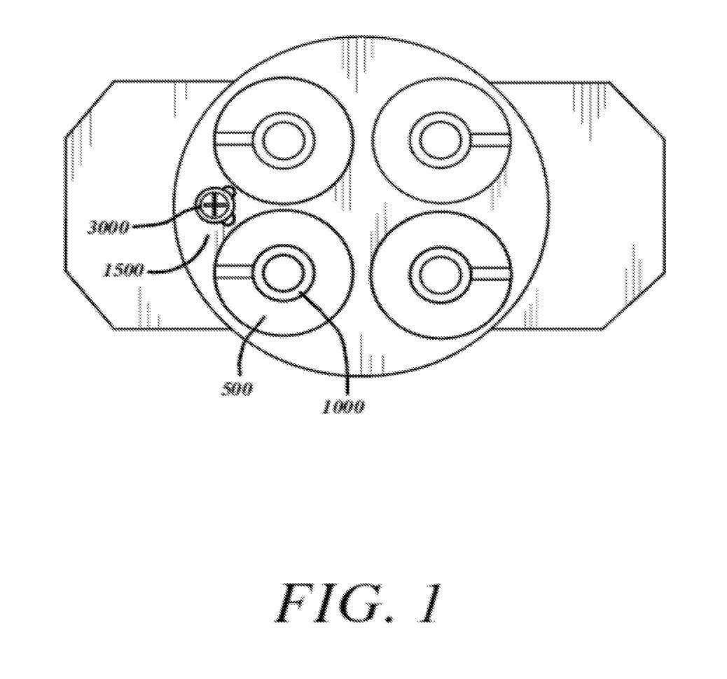

FIG. 1 is a top view of a four-barrel carburetor showing carburetor main body 1500 as having carburetor venturi openings 500. Within each opening 500 is booster 1000. The term “venturi” is used for the entire opening defined by opening 500 rather than just the narrowest portion of that opening. Situated on main body 1500 and between openings 500 is an accelerator pump discharge nozzle 3000. In stock condition, upon throttle movement, accelerator pump discharge nozzle 3000 sprays out fuel that enters into carburetor openings 500 and may splash against boosters 1000 in an attempt to atomize the streams of fuel. There may be one or more accelerator pump discharge nozzles 3000 for each set of openings 500.

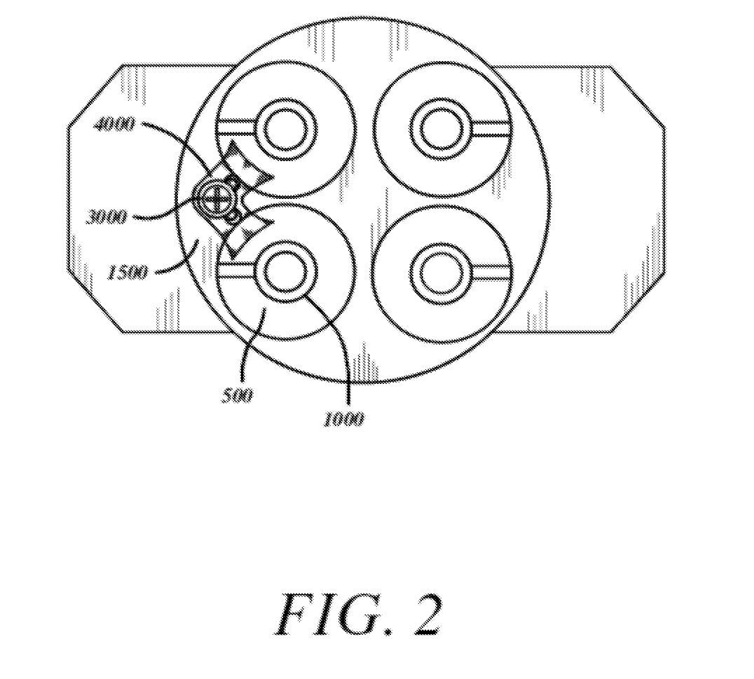

FIG. 2 is the same top view as in FIG. 1 with an embodiment of the atomizer plate connected thereto on one end of main body 1500. FIG. 2 shows the atomizer plate 4000 connected to or made as one unit along with the accelerator pump discharge nozzle 3000 of a carburetor.

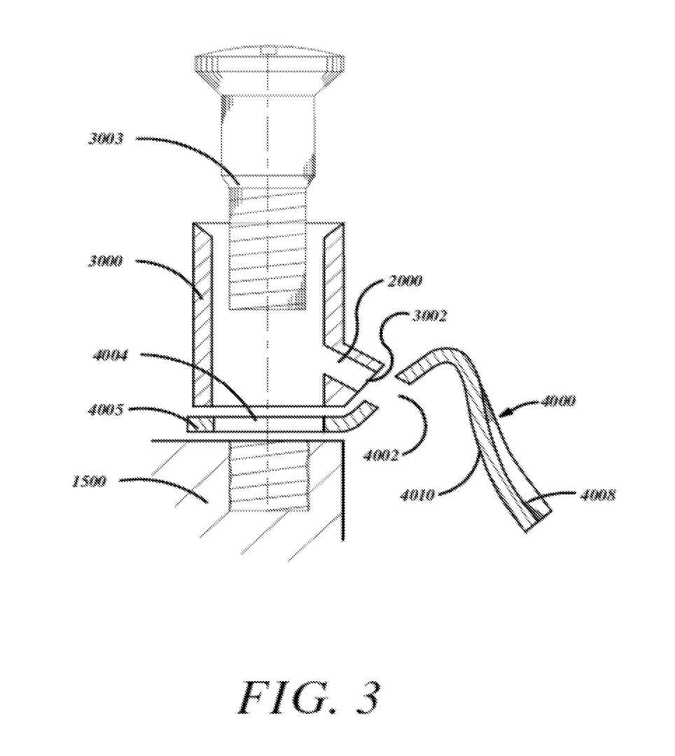

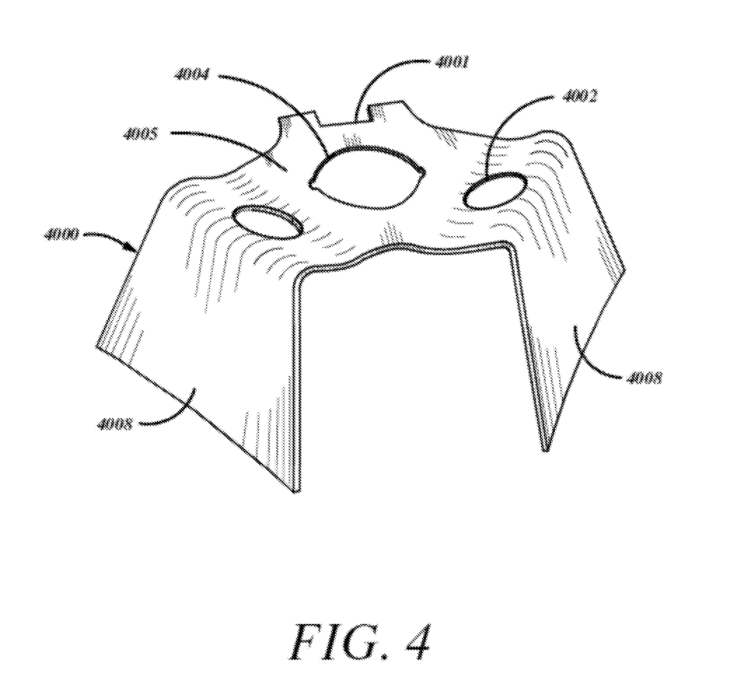

FIG. 3 is a sectional side view of a first embodiment of carburetor accelerator pump discharge nozzle atomizer plate 4000 located below nozzle 3000 and atop main body 1500. FIGS. 3 and 4 are particularly instructive in understanding this invention.

As can be seen in FIG. 3, retention screw 3003 extends through accelerator pump discharge nozzle 3000 and connection hole 4004 and into main body 1500. Connection hole 4004 is defined as generally located centrally about flat area 4005 of atomizer plate 4000. Fuel which passes through accelerator pump discharge nozzle 3000 and exits out exit hole 3002, passes through fuel hole 4002 defined on either side of and above connection hole 4004 in atomizer plate 4000, and impacts against the backside of fins 4008 of atomizer plate 4000. Atomizer plate 4000 is preferably made of cut, machined, stamped, formed or cast metal but may be made of any high temperature-rated and fuel-resistant materials.

Whereas FIG. 3 is a sectional side view of the first embodiment, FIG. 4 is a perspective view of atomizer plate 4000. The two fins 4008 of atomizer plate 4000 are located on either side of flat section 4005 and back edge 4001. Fins 4008 are bent, flared and curved in shape. As can be seen in FIG. 3, when the fuel flows out of exit hole 3002 it hits the backside of atomizer plate 4000 at or before the point of maximum curvature or bend 4010, and flows down to the tip of fin 4008 where the fuel is fanned out into a wide spray. In FIG. 4, both fins 4008 of the atomizer plate are clearly seen extending out at about a 45 degree angle from centerline of connection hole 4004. Connection hole 4004 may have indentations on either side for improved fuel flow up into accelerator pump discharge nozzle 3000 from main body 1500.

Some accelerator pump discharge nozzles 3000 have a tube extending from exit hole 3002. In such instances, fuel hole 4002 may be made large enough to accommodate the installation of atomizer plate 4000 with discharge nozzles 3000 that have these tubes, so that fuel can spray out of the tubes and impact against the backside of atomizer plate 4000 at or around bend 4010.

To review what has been disclosed with respect to FIGS. 1 through 4, one will note an atomizer plate 4000 having a first opening connection hole 4004 and second openings fuel hole 4002. The atomizer plate 4000 has a first center generally flat area 4005 where said first opening 4004 is defined. Fins 4008 extend from this area into a second area being made up of an up-sloping leg which extends up from flat area 4005 with second opening fuel hole 4002 near its center. This up-sloping relatively straight leg attaches to a down-sloping relatively straight leg that extends down and becomes a third relatively bent, curved and flared area, the maximum curvature or bend point being 4010.

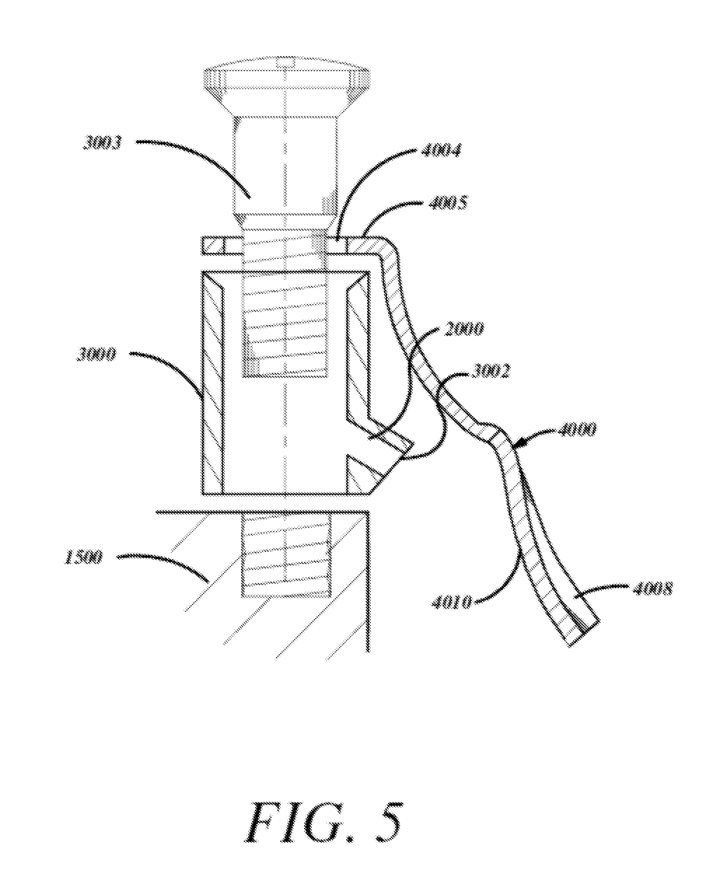

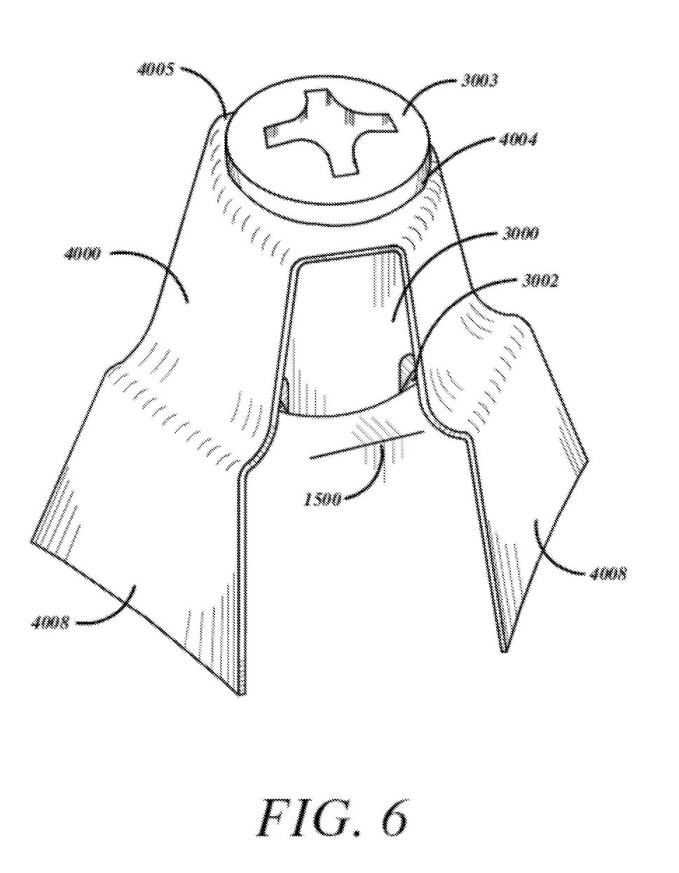

The atomizer plate can be made in different embodiments for many different accelerator pump discharge nozzle types or applications, such as for more rectangular style nozzles or more flat and wide style nozzles. A couple of different embodiments are described as follows: FIG. 5 is a sectional side view of the second embodiment of atomizer plate 4000, showing the location of first flat area 4005 as being on top of discharge nozzle 3000, and the modification of the second section so that the legs bend down over the sides of discharge nozzle 3000. This allows for the deletion of second opening 4002, so that the fuel flowing out of exit hole 3002 can impact directly against the backside of plate 4000 at or about point 4010. FIG. 6 is a perspective view of this embodiment of the invention.

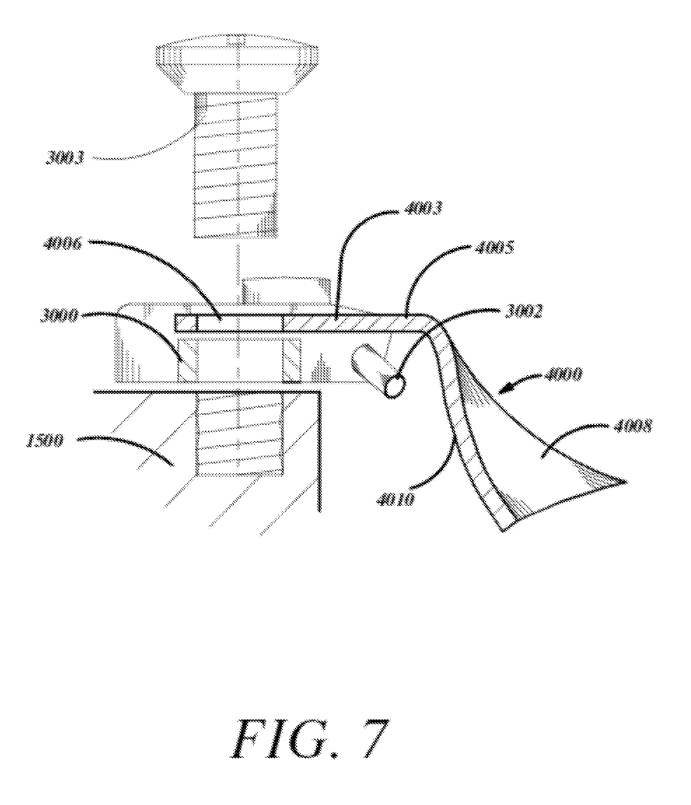

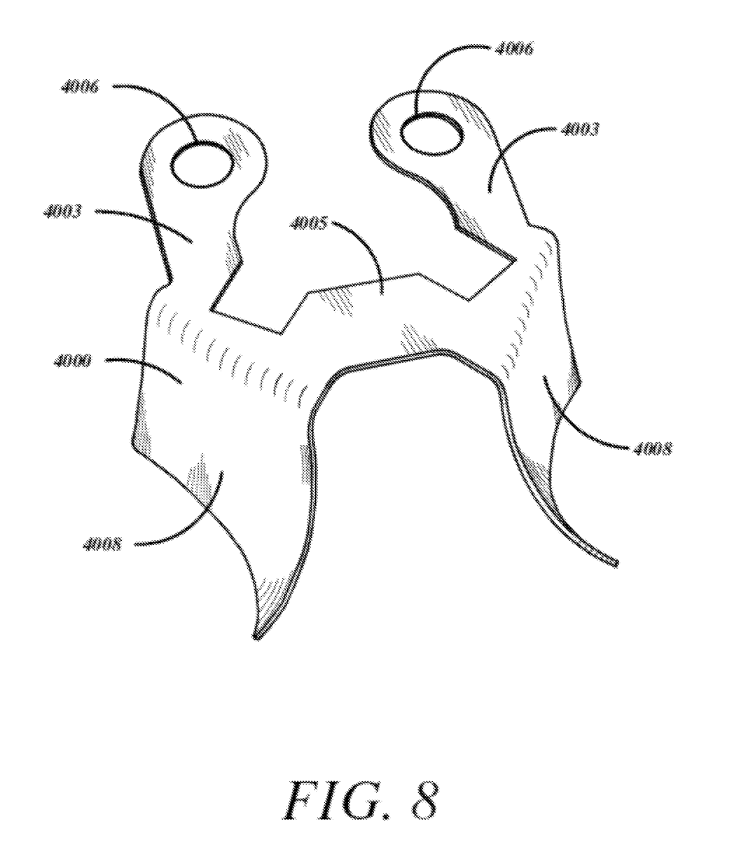

FIG. 7 is a sectional side view of the third embodiment of atomizer plate 4000, which shows the atomizer plate located on top of another type of discharge nozzle 3000. In this figure we have flat area 4005 with two relatively flat legs 4003 (seen more clearly in FIG. 8) extending back on both sides from the joint of fins 4008 and center flat area 4005. These legs each have a connection hole 4006 near the end for retention screws 3003 to pass through and into the discharge nozzle 3000 and main body 1500. FIG. 8 is a perspective view of this embodiment.

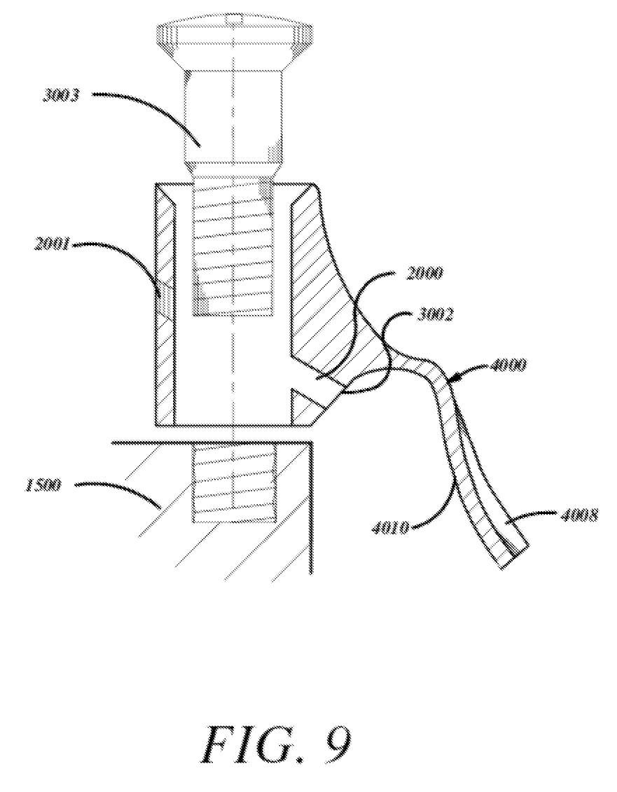

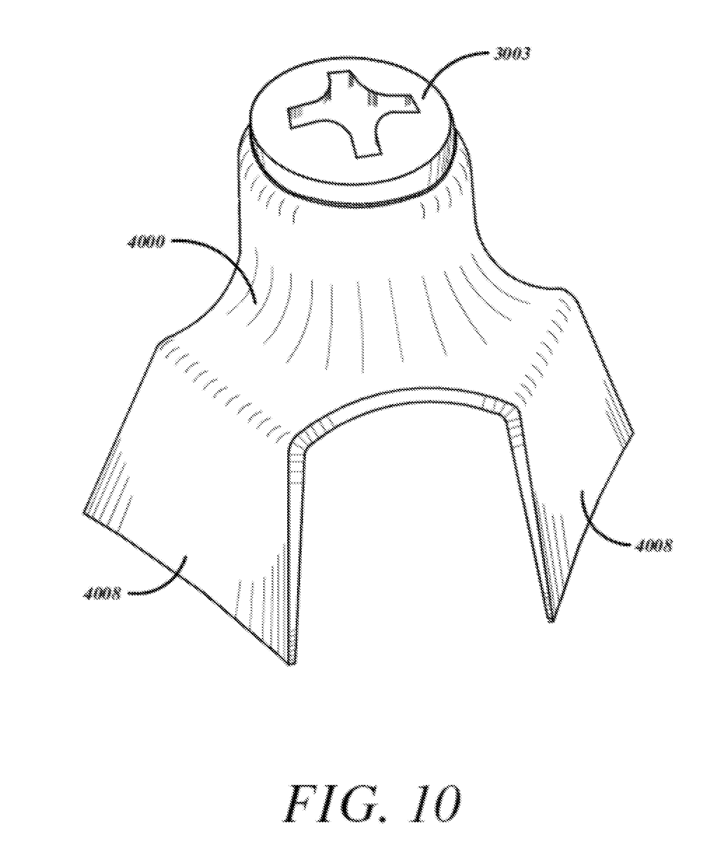

FIG. 9 is a sectional side view of the fourth embodiment of atomizer plate 4000 and shows atomizer plate 4000 and an accelerator pump discharge nozzle made as one unit. It may be required to drill fuel discharge passage 2000 from the back starting at drill hole 2001, as fin 4008 may inhibit the drilling of fuel discharge passage 2000 and fuel exit hole 3002. Drill hole 2001 should be permanently plugged if created. FIG. 10 is a projection view of this embodiment of atomizer plate 4000 showing its curved front face and retention screw 3003 at the top.

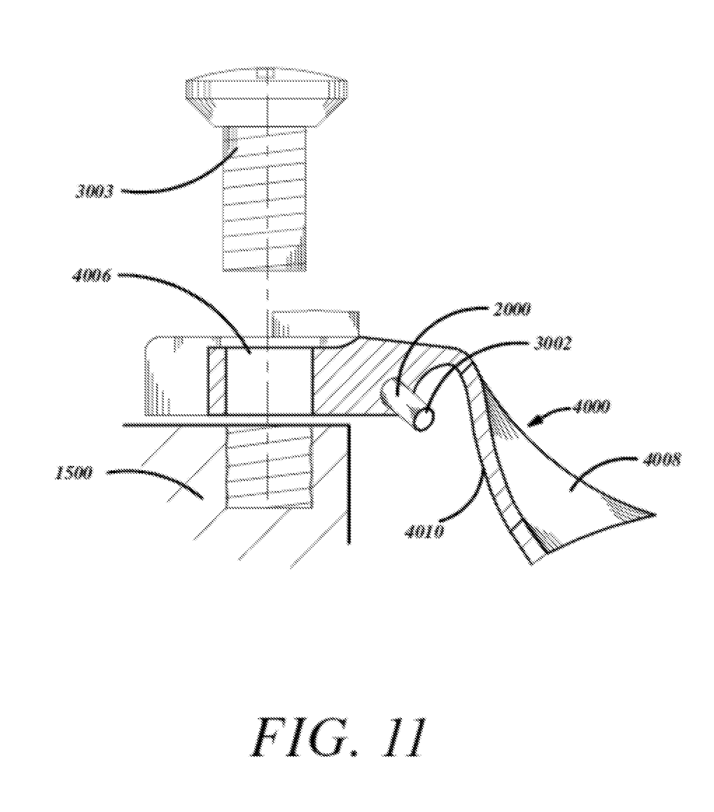

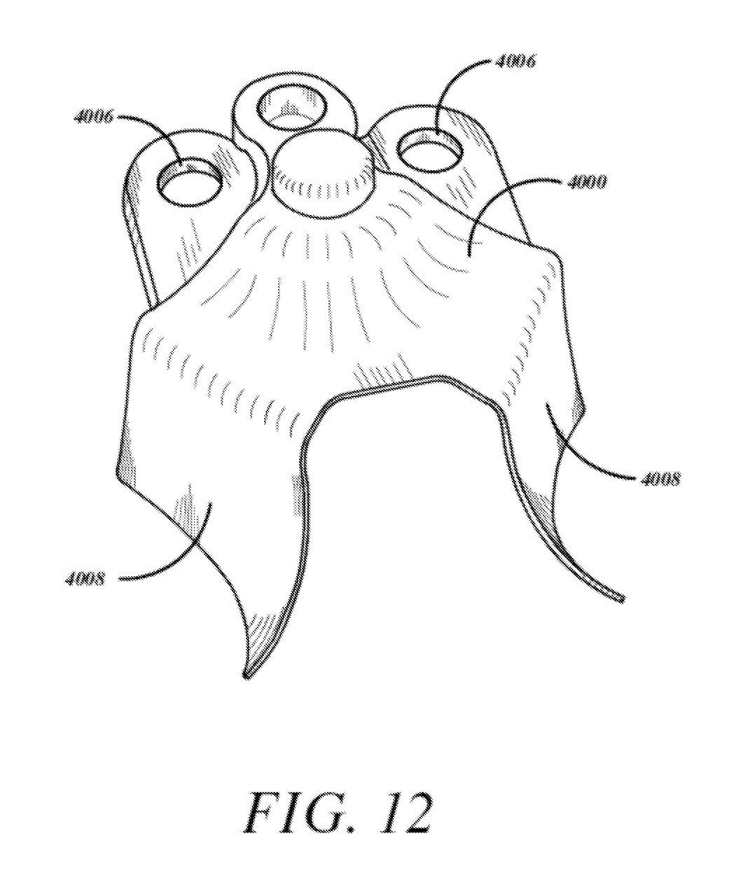

FIG. 11 is a sectional side view of the fifth embodiment of atomizer plate 4000 and shows atomizer plate 4000 and an accelerator pump discharge nozzle made as one unit in a lower profile design for certain carburetors. FIG. 12 is a projection view of this embodiment of atomizer plate 4000 showing its curved front face and connection hole 4006 on each side.

For carburetors with more than one accelerator pump discharge nozzle, an atomizer plate 4000 may be used for each accelerator pump discharge nozzle 3000, or in place of the separate discharge nozzle as in the case of single-unit embodiments, on the same carburetor.

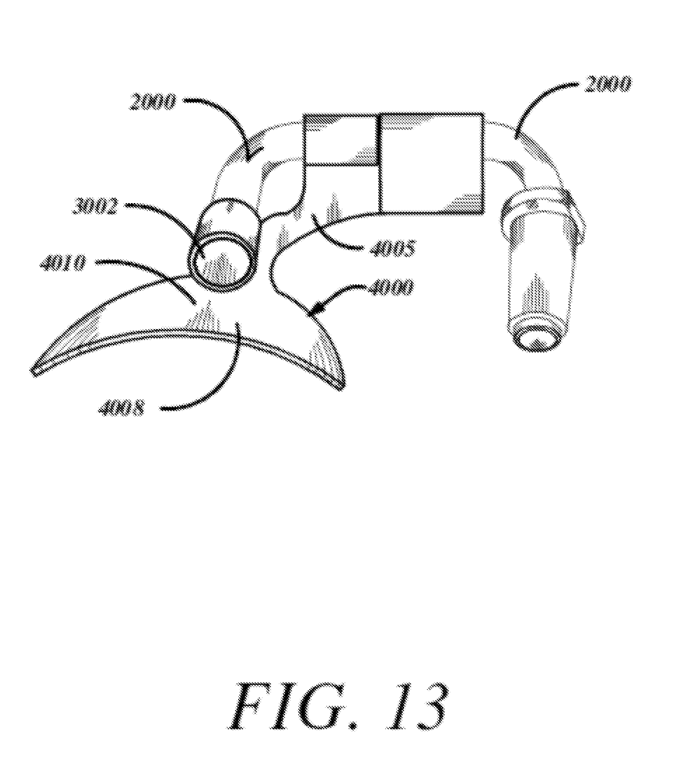

There can also be different embodiments for atomizer plate 4000 similar to the above for accelerator pump discharge nozzles, tubes or pipes with only one fuel exit hole 3002, as seen in FIG. 13, requiring a plate with one fin 4008. Similarly, there can be different embodiments for atomizer plate 4000 for accelerator pump discharge nozzles, tubes or pipes with multiple fuel exit hole 3002 requiring multiple fin 4008.

Although many parts have been described separately here they may instead be manufactured as a complete unit. For example, an atomizer plate manufactured as part of an accelerator pump discharge nozzle, tube or pipe. Further, parts that have been introduced as one piece could instead be manufactured for retrofit. For example, the atomizer plate in FIG. 13 could be manufactured as a separate piece from the discharge pipe and attached to the discharge pipe by means commonly understood by industry professionals. Those skilled in the art readily appreciate these modifications.

While downdraft carburetors have been presented herein, the atomizer plate is equally workable for updraft and side draft carburetors on all engine sizes and types. At times, such use will require minor and obvious modifications that those skilled in the art will readily appreciate.

1. A fuel atomizer plate for atomizing, dispersing and directing the fuel discharged from the accelerator circuit of a carburetor, comprising: a bent plate with a relatively flat center section and two equal length fins with bent, curved and flared surfaces that may follow the carburetor venturi shape and have a point of maximum curvature, said fins extending out and down on either side of said center section, the atomizer plate being formed by cutting, machining, stamping, or casting metal or any high temperature-rated and fuel-resistant materials.

2. An atomizer plate of claim 1, further comprising an indexing notch at the back of said flat center section, a first opening and second openings, up-sloping legs and down-sloping legs. Said first opening located about the center of said relatively flat center section at top of said plate to accommodate the passage of an accelerator pump discharge nozzle retention screw into the carburetor main body. Said first opening may also comprise indentations on either side of said first opening. Said second openings disposed in the up-sloping legs of said fins located on either side of said first opening. Down-sloping legs extending from a bend at end of said up-sloping legs terminating in said fins of bent, curved and flared surfaces.

3. An atomizer plate of claim 2 where said flat center section with said first opening is located on top of an accelerator pump discharge nozzle and a second area comprised of two down-sloping legs bending down over the sides of said discharge nozzle, attaching to a third generally down-sloping fin area relatively curved and flared on either side of said discharge nozzle.

4. An atomizer plate of claim 1, further comprising two relatively flat and equal length legs extending back from said flat center section with a whole near the end of each said leg.

5. An atomizer plate of claim 1, further comprising multiple fins on the same or opposing sides of said discharge nozzle.

6. An atomizer plate of claim 3 wherein said plate and said accelerator pump discharge nozzle are comprised of a single unit.

7. An atomizer plate of claim 4 wherein said plate and said accelerator pump discharge nozzle are comprised of a single unit.

8. An atomizer plate of claim 5 wherein said plate and said accelerator pump discharge nozzle are comprised of a single unit.

9. A fuel atomizer plate for atomizing, dispersing and directing the fuel discharged from an accelerator discharge tube or pipe of a carburetor, comprising: a round sleeve disposed above a single fin with a bent, curved and flared surface at one end of a straight leg and two attachment tabs on opposing side of said straight leg.

10. An atomizer plate of claim 9 wherein said plate and said accelerator pump discharge nozzle are comprised of a single unit.
